(19) United States
(12) Patent Application Publication
(10) Pub. No.: US 2002/0165880 A1
(43) Pub. Date: Nov. 7, 2002

(54) Digital book educational amusement device

(76) Inventors: James R. Hornsby, St. Louis, MO (US); Joseph L. McGowan, St. Charles, MO (US); Christian M. Mouser, Ballwin, MO (US); Jason E. Emde, St. Louis, MO (US)

Correspondence Address: David E. Bruhn, Dorsey & Whitney LLP, 220 South Sixth Street, Minneapolis, MN, 55402-1498, US

(21) Appl. No.: 09/932,386

(22) Filed: Aug. 17, 2001

Related U.S. Application Data
(60) Provisional application No. 60/226,434, filed on Aug. 18, 2000.

(51) Int. Cl. G06F 17/00

(52) U.S. Cl. 707/517; 707/515

(57) ABSTRACT

A digital book for providing reading education and amusement to a user. The digital book includes a visual display for displaying visual images and an audio component for broadcasting sound. The digital book includes a memory device for storing display images and a plurality of associated sounds. A processor controls the visual display to display a graphical image in association with a scrollable text segment.

### CROSS-REFERENCE TO RELATED APPLICATION(S)

This application claims priority to U.S. provisional patent application No. 60/226,434, filed Aug. 18, 2000, entitled, “DIGITAL BOOK AMUSEMENT DEVICE,” by James R. Hornsby et al.

### FIELD OF THE INVENTION

The present invention relates to a digital book amusement device. In particular, the present invention relates to an interactive electronic book capable of displaying both graphical and textural information and broadcasting sound.

### BACKGROUND OF THE INVENTION

Digital books known in the art typically include a visual display for producing a visual output to the user, a memory device for storing the displayed text and graphics, and a controller for controlling the visual display based on the information stored in the memory device. In a typical digital book, a removable memory device, such as a CD-ROM or memory device is used, so that the device may be used to display a wide variety of books. Typically each CD-ROM or memory device contains one book or one package of related content. These devices also generally include some type of interface to allow the user to move forward and backward through the electronic book. One such device is disclosed in U.S. Pat. No. 6,037,954 to McMahon. The McMahon device allows a user to select a document from a removable memory source and to step through the various pages of the selected document. The devices known in the prior art typically are difficult to use and require specialized knowledge and experience.

There is a need in the art for a digital book amusement device which is adapted for use by children. Accordingly, there is a need for a digital book which is durable, inexpensive, and easy to operate. There is a further need for a device which contains multiple modes of operation to retain the interest of the user and to provide the user with reading education.

### BRIEF SUMMARY OF THE INVENTION

The present invention, in one embodiment, is a digital book for providing reading education and amusement to a user. The digital book includes a visual display for displaying visual images and an audio component for broadcasting sound. The digital book further includes a memory device for storing display images and associated sounds, and a processor for controlling the visual display, using the display images, to display a graphical image in association with a scrollable text segment.

In one embodiment of the present invention, the digital book also includes a user interface, such as a keypad, for receiving input from the user. In one embodiment, the user interface includes a mode button, a page forward button, and a scroll button. In another embodiment, the digital book includes a touch screen display for receiving an input from the user.

One embodiment of the present invention is a method for controlling operation of an interactive digital book in response to an input from a user. In this embodiment, the method includes receiving a mode selection from the user, providing a visual output on a display, providing an audio output on a speaker, and controlling the visual output and the audio output, based on the mode selection.

While multiple embodiments are disclosed, still other embodiments of the present invention will become apparent to those skilled in the art from the following detailed description, wherein is shown and described only the embodiments of the invention, by way of illustration, of the best modes contemplated for carrying out the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. I is a front elevation view of a digital book according to one embodiment of the present invention.

FIG. 2 is a rear perspective view of the digital book shown in FIG. 1.

FIG. 3 is a schematic diagram showing the components of the digital book according to one embodiment of the present invention.

FIG. 4 is a flow diagram illustrating the operation of a digital book according to one embodiment of the present invention.

FIG. 5 is a perspective view of a memory device carrying case.

### DETAILED DESCRIPTION

FIG. 1 shows a front view of a digital book 10 according to one embodiment of the present invention. As shown in FIG. 1, the digital book 10 includes a housing 12, a visual display 14, a speaker 16, and a user interface 18. The housing 12 provides a support for the various components of the digital book 10, and it acts to protect the various components from damage during use and storage of the device. In one embodiment, the housing 12 also acts to create an attractive visual appearance and configuration. In one embodiment, the housing 12 further includes an overlay 20 which acts to provide an additional visual design to the housing 12. In one embodiment, the overlay 20 is removable and replaceable such that the user may vary the appearance of the housing 12 by replacing the overlay 20 with one of a different color or design. In one embodiment of the present invention, the housing 12 is constructed of an appropriate polymeric material, such as ABS. In one embodiment, the housing 12 is constructed from an opaque or translucent ABS material.

The visual display 14 operates to provide a graphical display to the user, which includes both graphical representations or text, or both. In one embodiment, the visual display 14 is an LCD screen, as known in the art. In another embodiment, the visual display 14 is a color display, such as a TFT display. In one embodiment, the visual display 14 includes touch screen capabilities to receive an input from the user based on contact with the touch screen. The speaker 16 is used to broadcast audio to the user. As further shown in FIG. 1, in one embodiment, the digital book 10 includes a volume control 22 that controls the output level of the speaker 16.

The user interface 18 acts as an input device and provides the user with the ability to control and influence the digital book 10. In one embodiment, the user interface 18 is a keypad. As shown in FIG. 1, in one embodiment, the user interface 18 includes a mode button 24, an enter button 26, a page forward button 28, a page back button 30, a scroll right button 32, and a scroll left button 34. The use of these buttons will be described in further detail below. In other embodiments of the present invention, the user interface 18 includes other combinations of keys or buttons to allow user input. In one embodiment, the digital book 10 includes additional inputs, such as buttons, gravity sensor or switch, keyboard, joystick, touch pad, or microphone, in communication with the microprocessor 52, to allow further interactivity with the user. In one embodiment, the operation of the digital book 10 does not require input from the user, and thus no user interface 18 is included.

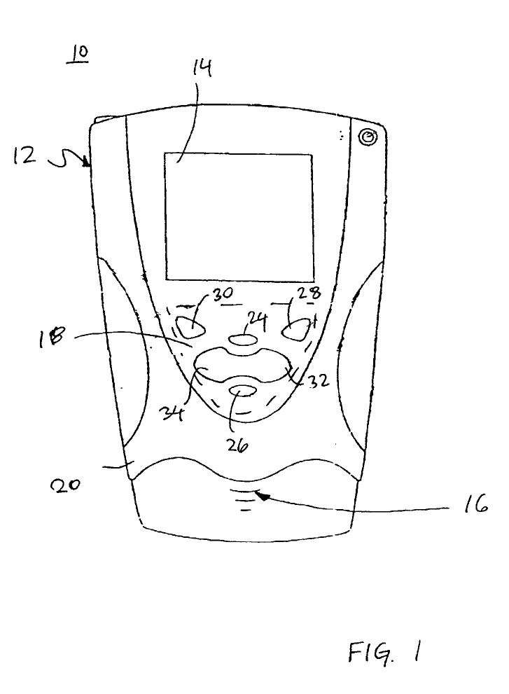

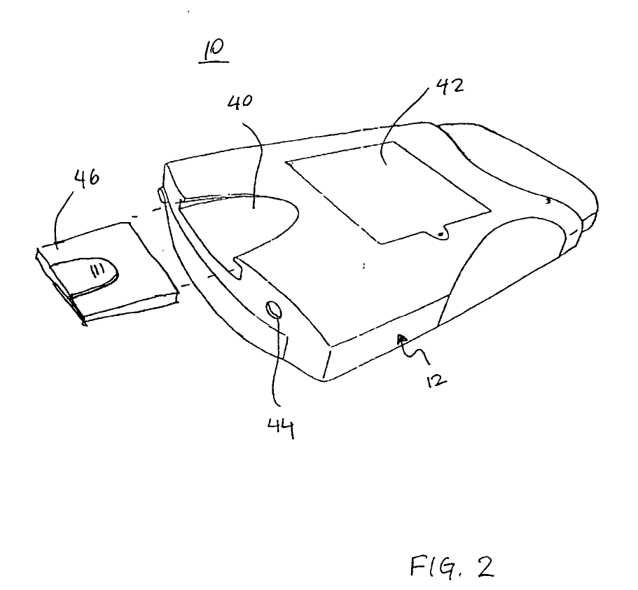

FIG. 2 shows a rear view of the digital book 10 according to one 20 embodiment of the present invention. As shown in FIG. 2, the digital book 10 includes a memory port 40, battery compartment 42, and an AC/DC adapter input 44. Also, in the embodiment shown in FIG. 2, the digital book 10 includes a memory device 46. The memory device 46 is adapted to mate with the memory port 40 and thereby form an electrical connection to a microprocessor of the digital book 10. The battery compartment 42 and the AC/DC adapter 44 provide two alternative methods for powering the digital book 10.

In one embodiment, the digital book 10 does not include a removable memory device 46, but instead includes a fixed memory device within the housing 12. In the embodiment shown in FIG. 2, the memory device 46 is a cartridge, which the user can readily remove and replace to change the content displayed by the digital book 10. In one embodiment, the memory device 46 includes one complete electronic book. The memory device 46 includes audio or graphical information, or both, for broadcast or display to the user.

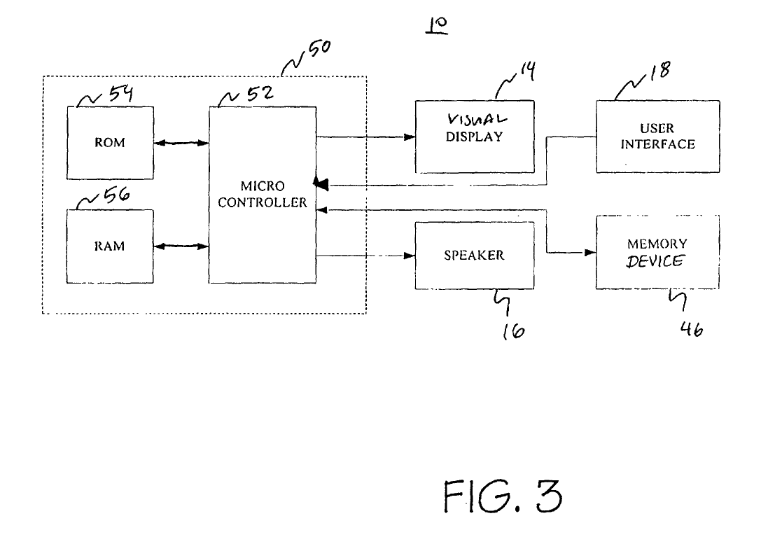

FIG. 3 shows a schematic view of the components of the digital book 10. As shown in FIG. 3, the digital book 10 includes a control circuit 50, the visual display 14, the speaker 16, the user interface 18, and the memory device 46. As further shown in FIG. 3, the control circuit 50 includes a microprocessor 52, a read-only memory 54 (ROM), and a random-access memory 56 (RAM). In one embodiment the ROM includes a stored set of computer instructions which are to be executed by the microprocessor 52. In one embodiment, the ROM is a conventional erasable, programmable, read-only memory (EPROM), which allows the stored computer instructions to be reprogrammed. In one embodiment, the control circuit 50 does not include RAM 56.

The control circuit 50 is in communication with each of the visual display 14, the speaker 16, the user interface 18, and the memory device 46. During operation, the microprocessor 52 operates to execute the computer instructions or software stored within the ROM 54. The microprocessor 52 reads information from the memory device 46. Based on instructions received from the user through the user interface 18, the microprocessor generates an appropriate signal to control the visual display 14 and the speaker 16. In one embodiment, the control circuit 50 does not include a general purpose microprocessor, but instead includes multiple chip sets (such as integrated circuits), each configured to accomplish a specific task. A variety of different configurations of controllers and memory can be used in the control circuit 50, as known to those skilled in the art.

The computer instructions or software included in the digital book 10 includes suitable modules for performing a number of data processing functions in connection with operation of the device. Potential functions include receiving and processing user input, producing or controlling audio output, producing and displaying visual outputs, and recording or downloading data. The configuration of the software can be varied in accordance with the desired functions. In one embodiment, one or more of the software modules are stored on the memory device 46, such that the functions of the digital book 10 may vary depending on the book associated with the memory device 46.

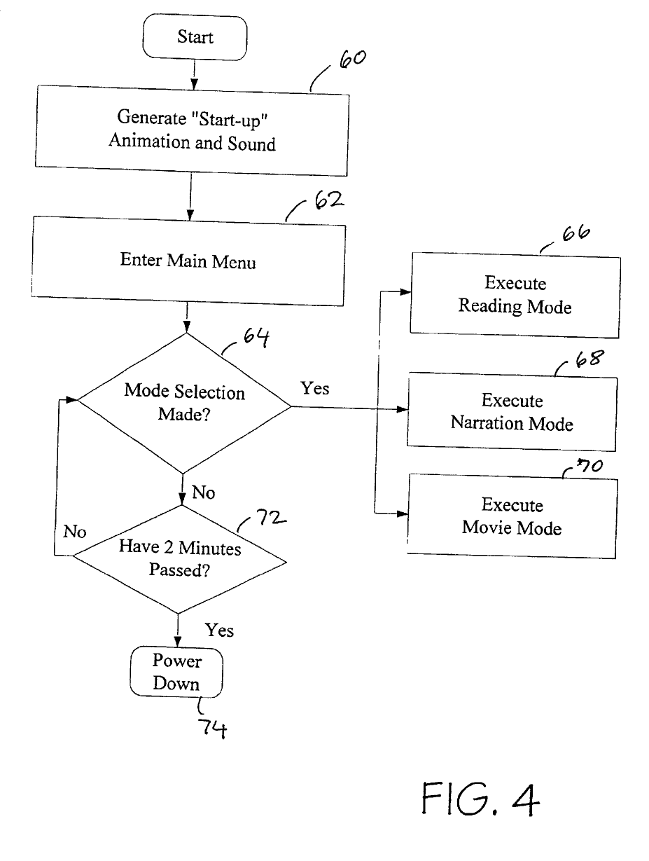

FIG. 4 is a flow chart showing the operation of the digital book 10, according to one embodiment of the present invention. As shown in FIG. 4, after the user activates the digital book 10 by pressing the power switch, the software stored in the ROM 54 operates to generate “start-up,” “animation” and “sound” (block 60). In one embodiment, the start up animation includes a graphical display on the display device 14. In one embodiment, it also includes a textural display, such as a text message. In one embodiment, the start-up routine also includes broadcast of sound from the speaker 16. After digital book 10 has completed the start-up animation and sound, it enters the main menu (block 62).

The digital book 10 then waits for the user to select a mode (block 64). The user then uses the mode button 24 and the enter button 26 to select the desired operating mode. In one embodiment of the present invention, the modes include a reading mode (block 66), a narration mode (block 68), and a movie mode (block 70). In other embodiments of the present invention, the digital book 10 includes only one, or any combination, of these three modes. If the user does not make a mode selection within a certain time period (block 72), the digital book 10 shuts down (block 74). In each of these modes, the actual audio or visual content is drawn from the memory device 46. In the embodiment in which the memory device 46 is removable, each memory device 46 may contain one or multiple digital books of information.

If the user selects the reading mode, the microprocessor 52 executes a set of computer instructions stored in the ROM 54 associated with the reading mode. In the reading mode, the digital book 10 displays a still graphical image on the visual display 14, and displays text associated with the graphical image on the digital display 14. In one embodiment of the reading mode, the microprocessor 52 also controls the speaker 16 to generate background music. In 5 the reading mode, the computer instructions or software allows the user to scroll the line of text displayed in the visual display 14 using the scroll right button 32 or the scroll left button 34. The line of text associated with the graphical image can be as long as is supported by the memory device 46.

After the user has completed reading the text associated with the first still image, the user may move to the next page of the digital book using the page forward button 28. The user may also move backward during use of the digital book 10 by using the page back button 30. When the user changes pages within the digital book, using the page forward button 28 or the page back button 30, a new still graphical image is displayed on the visual display 14 in association with a new scrollable line of text. In one embodiment of the present invention, the background music which plays, also changes as the page of the digital book 10 is changed.

In one embodiment, to support the reading mode, the memory device 46 includes a digital file including the images associated with each page and a digital file including the text associated with each image. In another embodiment, the memory device 46 further includes a file containing background music.

If the user selects the narration mode, the microprocessor 52 executes computer instructions associated with this mode. In the narration mode, a still image is displayed on the digital display 14 in association with a scrollable line of text. In the narration mode, however, the speaker 16 is supplied with a signal so that a narrator is heard reading the text displayed on the visual display 14. In the narration mode, the scroll right and scroll left buttons 32, 34 are inactive and the text line scrolls automatically in tempo with the voice of the narrator broadcast by the speaker 16. In one embodiment of the present invention, the rate at which the text scrolls and the narration is broadcast, is controlled by the user. When the end of the scrollable line of text is reached, the device waits for the user to navigate to another page within the digital book using either the page forward or page back buttons 28, 30. When the user selects a new page, the microprocessor displays the image for that page, again in association with a scrollable line of text. The text automatically scrolls across the visual display 14 while the voice of a narrator is broadcast from the speaker 16. In one embodiment of the narration mode, the speaker 16 also broadcasts background music, which may vary with each page of the digital book. In one embodiment, the narration mode uses the same digital files, associated with the graphical images and the scrollable text, as is used by the reading mode. The narration mode further includes a digital file containing the audio narration associated with the scrollable text.

In one embodiment of the present invention, one or both of the reading mode and the narration mode include hidden animations or “hot” spots. In this embodiment, the visual display 14 is a touch screen as known in the art, and when the user touches an activation spot on visual display 14, the microprocessor operates to play an animation on the visual display 14. In one embodiment of the present invention, the visual display 14 is a touch screen including a grid of activation spots. This grid, for example, may by five by five, creating a total of twenty-five activation spots. In one embodiment, the hidden animations are associated with one of the activation or hot spots. In another embodiment, a hidden animation is associated with multiple activation or hot spots. In embodiments of the present invention including hidden animations, the memory device 46 includes additional files containing the animation for display on the visual display 14. In embodiments of the present invention including hidden animations, the memory device 46 further includes a file which provides a map of the touch screen to determine which portions of the screen trigger which hidden animations. In one embodiment, this map is a set of links between positions on the touch screen and corresponding animation files.

In this embodiment, each page of the digital book may include one or more hidden animations, which may be activated by the user. In one embodiment of the present invention, activation of the hidden animation also triggers the broadcast of sound effects from the speaker 16. For example, the hidden animation may include a character moving and speaking. In one embodiment of the present invention, the digital book 10 includes a stylus adapted for assisting the user in activating the touch screen.

If the user selects the movie mode, the microprocessor 52 executes computer instructions associated with this mode. In the movie mode, the digital book 10 plays an animated scene associated with each page of the digital book 10. In the animated scene, the characters speak by the broadcast of sound through the speaker 16, and no narration is performed. In one embodiment of the movie mode, background music is broadcast by the speaker 16. The user may move to the next or the previous animated scene using the page forward button 28 or the page back button 30. In this embodiment, the audible narration is synched to the animated scene, so that it appears that the animated characters are speaking. In this embodiment, the memory device 46 includes an additional digital file containing an animation scene with synched audio.

In one embodiment of the present invention, the microprocessor 52 includes prompts for input from the user. The user then must respond through the user interface 18. This embodiment increases user interaction with the digital book 10, enhancing its educational and amusement effects. In one embodiment of the present invention, the digital book 10 includes lights attached to the housing 12 near the visual display 14. In one embodiment the lights are activated by the user to allow the user to operate the device in low light conditions. In one embodiment, the digital book 10 includes luminous or “glow-in-dark” features.

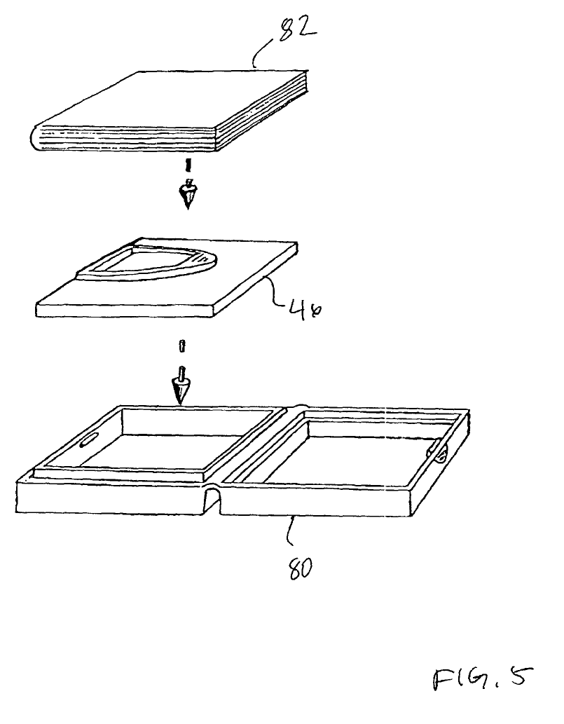

As shown in FIG. 5, in one embodiment invention, the memory device 46 includes a carrying case 80 adapted to hold the memory device 46 and a book 82. In this embodiment, the book 82 includes graphical images and text associated with those contained within the memory device 46. This “hard” copy 5 of the book allows the user to follow along with the digital book 10.

Although the present invention has been described with reference to preferred embodiments, persons skilled in the art will recognize that changes may be made in form and detail without departing from the spirit and scope of the invention.

We claim:

1. A digital book for providing reading education and amusement to a user, the digital book comprising:
a visual display for displaying visual images;
an audio component for broadcasting sound;
a memory device for storing data including a plurality of display images and a plurality of associated sounds; and
a processor for controlling the visual display, using the plurality of display images, to display a graphical image in association with a scrollable text segment.

2. The digital book of claim I further including a user interface for accepting input from the user.

3. The digital book of claim 2 wherein the user interface is a keypad including a mode button, a page forward button, and a scroll button.

4. The digital book of claim 2 wherein the user interface further includes a microphone for accepting audio inputs from the user.

5. The digital book of claim 1 further including a housing for supporting and protecting the visual display, the audio component, the memory device and the processor.

6. The digital book of claim 5 wherein the housing is constructed from ABS.

7. The digital book of claim 6 wherein the ABS is translucent.

8. The digital book of claim 7 wherein the housing further includes an overlay adapted to allow the user to change the visual appearance of the housing.

9. The digital book of claim I wherein the visual display is an LCD display.

10. The digital book of claim I wherein the visual display is a TFT color display.

11. The digital book of claim 1 wherein the visual display is a touch screen display adapted to receive a touch input from the user.

12. The digital book of claim 11 wherein the processor includes software for receiving input from the user via the touch screen display and for linking one or more selected portions of the touch screen display with one or more corresponding animation files.

13. The digital book of claim I wherein the memory device is a removable memory cartridge.

14. The digital book of claim 1 wherein the plurality of display images include a still graphical image and a scrollable text segment.

15. The digital book of claim 14 wherein the plurality of display images further includes an animated image.

16. The digital book of claim 1 wherein each of the plurality of display images are associated with a page of a book.

17. The digital book of claim I wherein the processor includes a reading mode adapted to display a still image in association with the scrollable text segment.

18. The digital book of claim 1 wherein the processor includes a narration mode adapted to display a still image in association with the scrollable text segment, and further adapted to broadcast the plurality of associated sounds from the audio component in synch with the scrollable text segment, wherein the plurality of associated sounds is a narration of the scrollable text segment.

19. The digital book of claim 1 wherein the processor includes a movie mode adapted to display an animated graphical image in association with the plurality of associated sounds.

20. The digital book of claim 1 wherein the visual display is a touch screen display adapted to receive a touch input from the user and further wherein the processor is adapted to detect the touch input and play an animation on the visual display, in response to the touch input.

21. An interactive digital book for providing reading education and amusement to a user, the digital book comprising:
a user interface for accepting input from the user;
a visual display for displaying visual images;
an audio component for broadcasting sound;
a memory device for storing data including a plurality of still images, a plurality of scrollable text segments, a plurality of animated images, and a plurality of associated sound tracks; and
a processor for controlling the visual display and the audio component, using the data stored in the memory device.

22. The digital book of claim 21 wherein the processor includes a reading mode adapted to display the plurality of still images in association with the plurality of scrollable text segment.

23. The digital book of claim 21 wherein the processor includes a narration mode adapted to display the plurality of still images in association with the plurality of scrollable text segments, and further adapted to broadcast the plurality of associated sound tracks from the audio component in synch with the scrollable text segments, wherein the plurality of associated sound tracks are narrations of the scrollable text segments.

24. The digital book of claim 21 wherein the processor includes a movie mode adapted to display the plurality of animated images in association with the plurality of associated sound tracks.

25. The digital book of claim 21 wherein the visual display is a touch screen display adapted to receive a touch input from the user.

26. The digital book of claim 25 wherein the processor includes software for receiving input from the user via the touch screen display and for linking one or more selected portions of the touch screen display with one or more of the plurality of animated images.

27. The digital book of claim 21 wherein the memory device is a removable memory cartridge.

28. A method for controlling operation of an interactive digital book in response to an input from a user, the method comprising:
receiving a mode selection from the user;
providing a visual output on a display;
providing an audio output on a speaker; and
controlling the visual output and the audio output, based on the mode selection, to display a graphical image in association with a scrollable text segment.

29. The method of claim 28 wherein the visual output includes a still graphical image and a scrollable text segment associated with the still graphical image.

30. The method of claim 29 further including receiving a scroll input from the user and controlling the position of the scrollable text segment based on the scroll input.

31. The method of claim 29 wherein the audio output includes a narration track associated with the scrollable text segment, and further comprising controlling the visual output and the audio output such that the scrollable text segment moves in synch with the narration track.

32. The method of claim 29 further including receiving a touch input from the user and controlling the visual output and the audio output based on the touch input.

33. The method of claim 32 wherein the touch input is received from a touch screen display.
